(19) United States
(12) Patent Application Publication
(10) Pub. No.: US 2002/0056628 A1
(43) Pub. Date: May 16, 2002

(54) Key or pushbutton assembly for an electric or electronic mechanism

(76) Inventor: Joaquin Aubert Capella, Barcelona (ES)

Correspondence Address: Striker, Striker & Stenby, 103 East Neck Road, Huntington, NY, 11743, US

(21) Appl. No.: 09/982,604

(22) Filed: Oct. 18, 2001

(30) Foreign Application Priority Data
Oct. 25, 2000 (ES) 200002601

(51) Int. Cl. H01H 9/00

(52) U.S. Cl. 200/314

(57) ABSTRACT

An illuminable key or pushbutton assembly for electric and electronic mechanisms includes a key-support base member, a cover portion made of translucent or transparent material which is sized to entirely cover the key-support base member, and an electroluminescent sheet mounted on the key-support base member and disposed between the key-support base member and the cover. The electroluminescent sheet is connected to means for providing an electric current, such as a contact on the mechanism itself. The electric current triggers the electroluminescent sheet and causes a luminic release, and the luminic release thereby illuminates the cover portion so that an observer can determine the position and location of the key or pushbutton assembly, as well as the electric or electronic mechanism. In a preferred form, the assembly includes a semi-opaque, exchangeable mask disposed between the electroluminescent sheet and the cover. The mask is positioned to block a portion of the luminic release visible to the observer and can include drawings, such as symbols, for locating or identifying the mechanism in an environment having limited visibility for the observer.

### BACKGROUND OF THE INVENTION

The present invention relates to key or pushbuttons for driving or controlling electric or electronic mechanisms.

More particularly, the present invention relates to a key or pushbutton assembly for driving or controlling electric or electronic mechanisms, the key-pushbutton having electroluminescent elements for signalization or determining the position or location of the key-pushbutton.

In current, common techniques of electric power distribution in the home as well as at the industrial level and in techniques for sending, transmitting, and distributing information by means of cable ducts or fiber optics, it is essential that a large range of electric and electronic mechanisms can be employed for facilitating driving, connecting, commuting, and lighting operations installed in the conducting or distributing network. For instance, electric and electronic mechanisms utilizing pushbuttons, switches, prong plugs and the like are frequently used for driving and controlling various apparatuses and instruments in residential as well as industrial environments.

In either a residential or industrial setting, it is imperative that the user may locate the electric or electronic mechanism very quickly and safely, thus necessitating a means for determining the location and position of the mechanism, especially in environments having low or limited visibility, either because of lack of illumination or because of the presence of fumes or gas. Thus, a need exists for a key or pushbutton on electric and electronic mechanisms which includes a source of illumination which allows the key or pushbutton to be located and operated in environments having limited visibility.

### SUMMARY OF THE INVENTION

It is therefore an object of the present invention to provide a key or pushbutton assembly for an electric or electronic mechanism having electroluminescent elements which, in a simple and effective manner, allow the user to quickly locate the mechanism to be operated.

In the assembly of the present invention, an electroluminescent element is provided, in which the luminescence is provoked by electrical excitations. This phenomenon produced a high energetic performance which, in turn, produces a high release of light commonly known as “cold light”. That is, the electroluminescent elements produce a strictly luminic release when excited by an electric current, without any associated heat production.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is an exploded, perspective view of the various elements of the key or pushbutton assembly for electric or electronic mechanisms according to the present invention; and

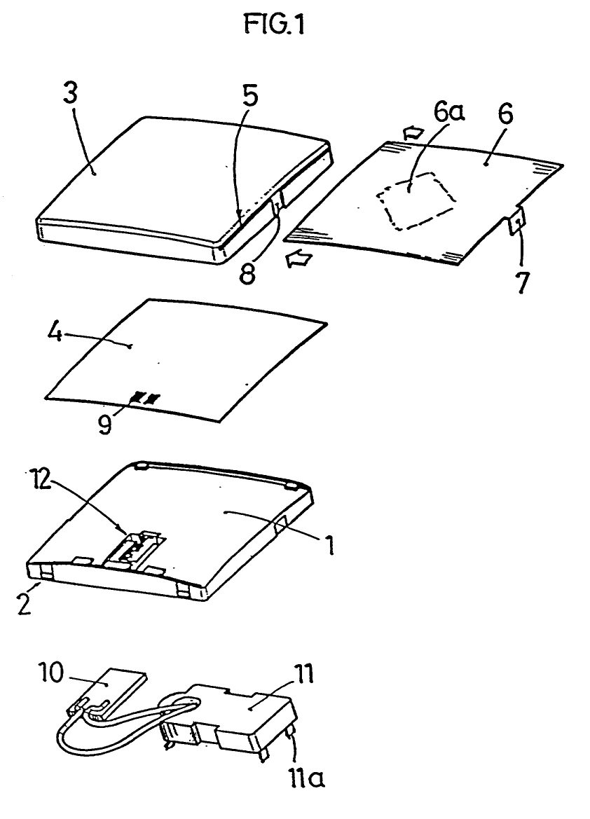

FIG. 2 is a sectional view of the assembled elements of the key or pushbutton assembly of the present invention.

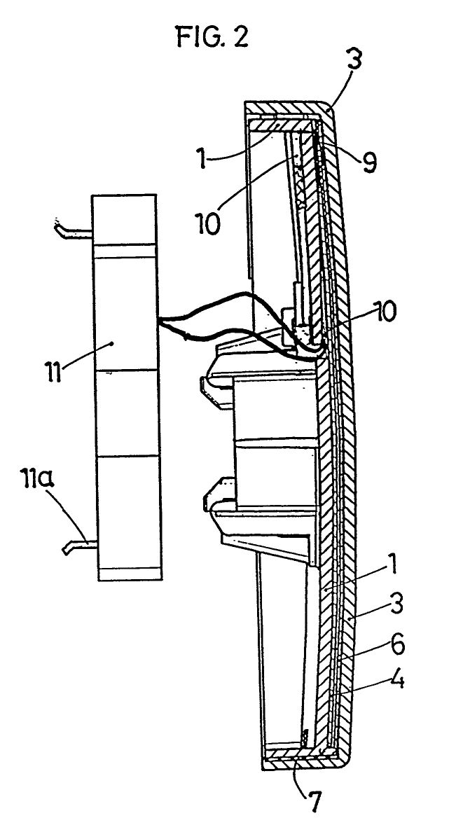

### DESCRIPTION OF THE PREFERRED EMBODIMENTS

As shown in the accompanying figures, the external portion of an electric or electronic mechanism is shown, which is used for driving or controlling the mechanism, namely the key or button which the user will activate. This key or pushbutton, shown in the figures as having a quadrangular shape (although other shapes obviously can be employed to the same effect) has a key-support base member 1 with a slightly curved surface. The key-support base member 1 includes recesses 2 on its sides for positioning and securely fastening a transparent cover 3 onto the key-support 2. The cover 3 may also comprise a translucent and colored material, as the specifications may require. The key support base member 1 includes in a lower portion a supporting block, preferably formed as a truncated pyramid, which is supported on and embedded with a switching or rocking element of the related switch or button, which carries out the tilting movement of the switch or button.

An electroluminescent sheet 4 is disposed between the key-support 1 base member and the cover 2. The shape of the sheet 4 conforms to the shape of the cover 3, shown by way of example as a quadrangular shape in the accompanying figures. The outer perimeter of the sheet 4 corresponds to the inner dimensions of the cover 3, so that the sheet 4 is fully embedded and secured within the cover 3. The cover 3 has a horizontal slot 5 on one side. A semi-opaque mask 6 is introduced and guided into the slot 5 by internal guides in the cover 3. The mask 6 has a tongue or tab 7 on one side. When the mask is introduced through the slot 5 of the cover 3, the tongue 7 will remain housed within a recess 8 in the cover 3 which is disposed below the side slot 5. This tongue 7 facilitates the withdrawal of the mask 6. The mask 6 is exchangeable, thus allowing for different masks to be used and placed, as will be described in more detail below.

The electroluminescent sheet 4 includes at least one graphite contact 9 disposed on one side. The graphite contacts 9 are supported on a contact holder 10 of a connector 11, disposed below the key-support base member 1, when the sheet is properly placed within the assembly. The contact holder 10, which is provided with related contacts on which the contacts 9 of the sheet 4 are supported, remains locked within the key-support housing 12.

The connector 11 includes contact pins 11a which contact the body of the electric or electronic mechanism (not shown in the figures) continuously when the inventive assembly is mounted, such that the connector always remains connected to a permanent, current supply area. Thus, the electroluminescent sheet 4 is also continuously fed through the connector 11 and the contacts of the contact holder 10, which, in turn, transmit the electric flux to the sheet 4 through the graphite contacts 9, thereby provoking the desired luminic release.

As noted above, an object of the present invention is to provide a key or pushbutton assembly which can be viewed from an observer during environments with limited visibility. In this connection, the semi-opaque mask 6 is embedded between the electroluminescent sheet 4 and the transparent or translucent cover 3. The mask 6 is provided with a drawing or a concrete sign 6a which delimits an area more transparent than the remainder of the mask 6. Preferably, this drawing 6a is a die-cut drawing. The drawings 6a may comprise selected symbols which are chosen to designate specific applications of the key or pushbutton. This die-cut drawing 6a allows the luminic release from the sheet 4 to be clearly seen by an observer. More particularly, when the observer views the key-support 1 of the mechanism, a lighted area is clearly seen which corresponds to the drawing 6a cut in the mask 6 and which indicates to the observer the particular application of the mechanism.

In the case when symbols are not required to indicate to the user the respective application of the key or pushbutton, that is, when it is only desired to locate the position of the electric mechanism, the mask 6 may be fully transparent so that the entire key-support 1 is illuminated through the cover 3, due to the luminic release from the sheet 4. It is also contemplated that no mask 6 could be employed in the assembly.

While the invention has been illustrated and described as a key or pushbutton assembly for an electric or electronic mechanism, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A key or pushbutton assembly for electric and electronic mechanisms, comprising:
a key-support base member;
a cover comprising translucent or transparent material sized to entirely cover said key-support base member;
an electroluminescent sheet mounted on said key-support base member and disposed between said key-support base member and said cover when said assembly is in an assembled state;
means for providing an electric current to said electroluminescent sheet, wherein said means triggers said electroluminescent sheet and causes a luminic release, said luminic release thereby illuminating said cover portion so that an observer can determine the position and location of said key or pushbutton assembly and said electric or electronic mechanism; and
a semi-opaque, exchangeable mask disposed between said electroluminescent sheet and said cover, said mask positioned to block a portion of said luminic release visible to the observer for locating or identifying said mechanism in an environment having limited visibility for the observer.

2. The assembly according to claim 2, wherein said electroluminescent sheet has at least one graphite contact, and wherein said key-support base member has a contact holder, said graphite contact position on a side of said sheet to correspond with contacts disposed on said contact holder, said contact holder connected to a connector for continuously receiving an electric flow from a contact area of said electric or electronic mechanism.

3. The assembly according to claim 1, wherein said cover has a slot, said slot disposed on a side of said cover and including a recess, said mask having a tongue disposed on a side of said mask, wherein said tongue is received into slot and secured in said recess upon assembly of said key or pushbutton assembly.

4. The assembly according to claims 1, wherein a surface area of said mask has a selected drawing or sign, said drawing or sign delimiting an area of the cover more transparent than the remainder of the cover, whereby only said luminic release emerging through said surface area of said mask is visible to said observer, wherein said delimited area of the cover serves to identify or locate said mechanism.

5. The assembly according to claim 1, wherein said mask is fully transparent, whereby the entirety of said key-support base member is illuminated through the cover from the luminic release generated by said electroluminescent sheet.
